(19) United States
(12) Patent Application Publication
(10) Pub. No.: US 2016/0346578 A1
(43) Pub. Date: Dec. 1, 2016

(54) FIRE FIGHTING APPARATUS FOR TALL BUILDINGS

(71) Applicant: Regional Energy and Environment Est., Riyadh (SA)

(72) Inventor: Istvan Szocs, Budapest (HU)

(73) Assignee: Regional Energy and Environment Est., Riyadh (SA)

(21) Appl. No.: 15/117,200

(22) PCT Filed: Feb. 6, 2015
(86) PCT No.: PCT/IB2015/000247

§ 371 Date: Aug. 7, 2016

(30) Foreign Application Priority Data
Feb. 7, 2014 (HU) P1400063

(51) Int. Cl. A62C 35/02; A62C 5/02; A62C 35/68; A62C 3/00

(52) U.S. Cl. CPC A62C 35/023; A62C 3/00; A62C 5/024; A62C 35/68; A62C 99/0036

(57) ABSTRACT

The fire fighting apparatus is equipped with a tank containing an extinguishing agent, a pipeline to forward the extinguishing agent, and a device to spread the extinguishing agent, particularly a nozzle. The tank (10) is located in a lower space of the building; the pipeline to forward the extinguishing agent is ascending pipeline (15) fixed along the height of the building; there are pipe sections branching off the ascending pipeline (15) at specific heights; and there are local shut-off devices and tools to spread the extinguishing agent at the end of each pipe section. The tank (10) is equipped with a gas space and the extinguishing agent inside it is a foam composition comprising water, a foaming agent, and in the solution of these two, a non-combustible foaming and propellant gas diluted or emulgeated under overpressure. The ascending pipeline (15) is connected to the fluid space of the tank (10), with a main valve (12) between the tank (10) and the ascending pipeline (15), and/or a local valve in branch sections.

The invention relates to a fire fighting apparatus for tall buildings, most of all high-rise buildings, skyscrapers and the like.

It is known that in case of fire fighting at buildings of 20 to 50 m, classified as buildings of “medium height”, the usability of ascending dry hydrant conduits installed in such buildings is dubitable. Frequently, hydrant cabinets installed at each floor are opened irresponsibly, the hoses and nozzles placed there are stolen, the tap of the ascending conduit is opened and left open by unidentified perpetrators. Consequently, after several failed attempts of use, fire fighting facilitated by the use of dry ascending conduits has been replaced by a tactical practice of fire fighters arriving at the site to extinguish the fire by using reliably operating technology brought with them (water, hoses, nozzles). As necessary, water is also taken from hydrant water sources available in public areas (hydrants), and the booster pumps of fire fighter vehicles can satisfy the water demand of fire fighting in case of buildings of such height, although this involves time delays and represents major physical overloads for fire fighters.

In the course of the past decades, however, 100-150 m tall buildings have been erected in masses, and more sporadically buildings of 400 to 600 m height. Potable water supply for such buildings can be provided relatively easily by traditional building engineering equipment and multi-stage pressure boosting, but it is a major technical task to provide quantities of water required for fire protection and fire fighting at the appropriate pressure.

In the area of hydrant water supply, difficulties arise in case of buildings over 50 m, particularly over 100 m of height. The hydrant water applied, of 1 g/cm³ density, generates a hydrostatic pressure of 1 bar upon each 10 m of height at the lowest water feed point. In case of such a geodetic height, the delivery output of traditional fire fighting vehicle pumps capable of producing 10-12 bars becomes very low. Further problems include the assembly and routing of hydrant hoses leading to top floors.

In case of buildings classified as “very high”, special building engineering solutions must be applied for the water supply of water-based extinguishing equipment and interventions. (Society of Fire Protection Engineers: www.sfpe.org/SharpenYourExpertise/ . . . /VeryTallBuildings.aspx)

Traditional solutions are discussed by the American International Building Code (http://en.wikipedia.org/wiki/International Building Code), the Federal Emergency Management Agency (www.fema.gov), the National Fire Protection Association (www.nfpa.org/), and applicable national regulations.

A customary technical solution is to place hydrant water tanks at the uppermost level, wherefrom the fire protection system of the building is supplied with water by gravitation. It is also a problem here that hydrostatic pressure increases excessively at lower levels, but it is handled by interposed pressure controllers.

These protection systems are usually sprinkler based, extinguishing by water from automatic sprinkler heads opening by heat, installed in rooms, corridors and stairways.

Such fire fighting equipment carries several disadvantages. Primarily by reason of tanks to store large quantities of water, placed at the uppermost level, the building will be “top heavy”, which is a risk factor in itself in case of an earthquake hazard, deteriorating the stability of the building and entailing considerable extra costs in building design and construction. The use of water of relatively high density (1 g/cm³) as an extinguishing agent requires the application of pressure-tight pipelines for large differences of height. At fire fighting, the water soaks building structures and furnishings through floors, representing secondary damage by water, the extent of which depends on the decision of the operator staff or the fire fighters as they are authorized to shut off sprinkling.

Therefore the task is to provide a fire fighting apparatus suitable for fire fighting in buildings of middle height and in taller and in very tall buildings.

The invention is based on the perception that it is expedient to apply an extinguishing agent of lower than the 1 g/cm3 density of water for fighting fires at heights, as it can be pumped higher than water by pumps to generate traditional pressure levels. So if an extinguishing agent of 0.1 g/cm3 density is applied, then at a height of 10 m a hydrostatic pressure of only 0.1 bar needs to be reckoned with. By applying 1 bar of pressure, the extinguishing agent can be pumped up to 100 m of height. The hydrostatic pressure at rest at ground level of the fire fighting equipment of a 600 m high building is only 6 bars.

In order to apply such an extinguishing agent, however, a working pressure of e.g. 5 bars is also required at the outlet point of the fire fighting nozzle depending on the type of nozzle; therefore, taking the example of the 600 m high building, a feed pressure of 6+5=11 bars must be provided at ground level. For this purpose, the extinguishing agent of only 0.1 g/cm³ density must be kept available at ground level.

A further perception was to opt for fire fighting foam as a low-density extinguishing agent. In such a case, a pressurized propellant can be applied for moving the foam.

Therefore the solution of the task according to the invention is a fire fighting apparatus for tall buildings, equipped with a tank containing an extinguishing agent, a pipeline to forward the extinguishing agent, and a device to spread the extinguishing agent, particularly a nozzle.

The apparatus is essentially characterized by the fact that the tank is located in a lower space of the building; the pipeline to forward the extinguishing agent is ascending pipeline fixed along the height of the building; there are pipe sections branching off the ascending pipeline at specific heights, expediently at each floor; and there are local shut-off devices and tools to spread the extinguishing agent at the end of each pipe section; where the tank is equipped with a gas space and the extinguishing agent inside it is a foam composition comprising water, a foaming agent, and in the solution of these two, a non-combustible foaming and propellant gas diluted or emulgeated under overpressure; the ascending pipeline is connected to the fluid space of the tank (10); with a main valve between the tank and the ascending pipeline, and/or a local valve in branch sections.

In a preferred embodiment of the apparatus, the device to spread the fire extinguishing foam composition is nozzle and/or sprinkler.

In a further preferred embodiment of the apparatus, the foaming gas and the propellant gas are of the same kind of gas, preferably carbon dioxide.

In yet another preferred embodiment of the apparatus, the foaming gas and the propellant gas are a gas mix, preferably a gas mix with carbon dioxide content.

Non-combustible foaming agents commercially available can be applied as a foaming agent.

In the solution according to the invention, an extinguishing agent as foam composition is kept in reserve in a tank as a pressure vessel located at ground level or below. By way of its expansion at atmospheric pressure, the attainable density is in the range of 0.1 to 0.05 g/cm3. Such a foam composition is characterized by the fact that having been released from a closed tank into a space of lower pressure, its volume increases and its density decreases in proportion to the extent of pressure drop. The fire fighting foam ready for use is produced by the expansion, at atmospheric pressure, of the foaming and propellant gas diluted or dispersed in the composition: foam bubbles obtain their size in the course of expansion.

The tank has adequately placed loading devices, pipe ends and valves, etc. to introduce foam components, and is equipped with a pressure gauge.

At the same time, it can be achieved by proper construction of the tank and the ascending pipeline connected thereto that upon the expansion, at atmospheric pressure, of the fire fighting foam composition stored in the pressurized tank, the foam composition is pressed through by overpressure to a space of atmospheric pressure, that is, to the place of use.

A control unit of appropriate construction, as well as mechanical, pneumatic, hydraulic, electric or electronic fire alarm sensors can be connected to the apparatus according to the invention.

The essence of the fire fighting apparatus according to the invention is presented in more detail below by describing its preferred embodiment, with reference to the schematic drawing enclosed, where

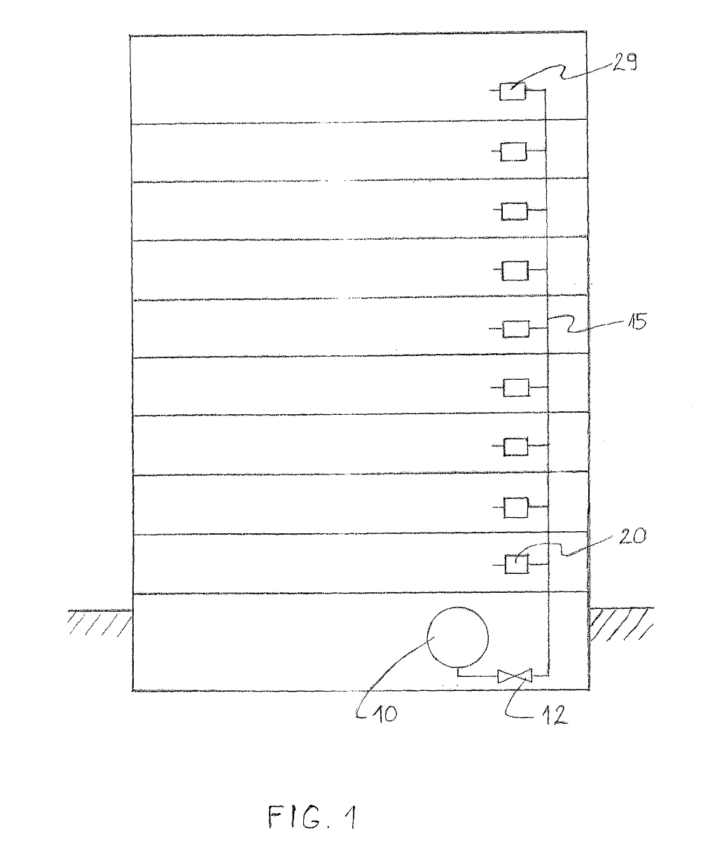

FIG. 1 shows the conceptual arrangement of a fire fighting apparatus in a 9-floor building.

The fire fighting apparatus is equipped with a tank (10) located in the lower space of the 9-floor building according to the example, at the ground floor or below, within underground premises in the present example.

An ascending pipeline (15) is connected to the tank (10) by intercalating a main valve (12), which, similarly to a traditional “ascending dry hydrant conduit”, is led upwards and fixed in the public utility shaft of the building along the height of the building.

From the ascending pipeline (15), branches are installed in numbers as required at each floor of the building in order to release the fire fighting foam.

Branches can be constructed as hydrant cabinets (20 . . . 29) similar to a traditional “wall-mounted hydrant cabinet” design, where a hose is connected each branch through the insertion of a cut-off fixture, and a device to spread the fire fighting foam, preferably a nozzle, is fixed to the end of the hose. Such wall-mounted hydrant cabinets are robust, sabotage-proof, and are allowed to be opened only by specific persons such as fire fighters, only specific persons have special keys to them.

Branches can also be constructed by inserting a cut-off fixture and continuing in pipelines leading to rooms at the given floor, to the end of which e.g. sprinklers are fixed.

Fire fighting is always performed by opening the point of the pipeline network closest to the fire, consequent upon which pressure is reduced in the tank (10) and as a result, the fire fighting foam composition is expanded and discharged, to be followed by fire fighting with foam.

The volume of the tank (10) is calculated in line with the required fire safety level. In calculations of the required volume, the following are taken into consideration: the foam of large volume produced by the expansion if the foam composition, its increased extinguishing effect and smoke absorption capability. The tank (10) is dimensioned hydraulically for 16 bar pressure, which can push up the fire fighting foam up to 600 m height at least, the height of an extremely tall skyscraper, when applying foam of 0.1 g/cm³ specific weight and min. 5 bar output pressure.

The greatest advantage of the apparatus according to the invention is that as its extinguishing agent is a foam of much lower specific weight than water, it can be pumped higher than water at a given pressure. Thus, by storing the fire fighting foam as a foam composition under pressure in the tank, the pressure in the tank can pump up the foam without any additional energy input through the ascending conduit connected to the tank to the desired height, where it can be further conducted horizontally and used properly for fire fighting. Another great advantage in this context is that the pressure to move the fire fighting foam is generated while producing the fire fighting foam composition itself in the tank, so the pressure required for moving the fire fighting foam composition is also accumulated in the tank as early as the foam composition is produced.

A further advantage of the apparatus according to the invention is that the extinguishing effect of the fire fighting foam is based on a method of covering: the fire is primarily extinguished by sealing off objects on fire from air and oxygen, and a cooling effect prevails to a lesser extent. The fire fighting foam is highly resistant to thermal loads, being less damaged by fire.

Yet another advantage of the apparatus according to the invention is that the fire fighting foam spread out, particularly when spread in the form of a split jet, absorbs a considerable part of the smoke produced, thus reducing the hazard of smoke inhalation. Another considerable advantage is that there is no secondary damage by water as earlier when hydrant water was used, so after fire fighting the foam, free of water precipitation or precipitating very little water, can be easily removed by sweeping, wiping, or vacuum-cleaning, and the water or the foam solution cannot flow down to lower floors.

Yet another advantage of the apparatus according to the invention is that in practical fire fighting applications, the pressure in the tank is usually 16 bars, which is a general industrial standard. Prices of fixtures dimensioned for this pressure are low, requiring low investment costs. cm 1. Fire fighting apparatus for tall buildings with several storeys, comprising a tank (10) containing a liquid foam forming composition that comprises the mix of water, a foaming agent and a non-combustible foam forming gas and a gas space above the liquid, an overpressure is provided in the container of at least 5 bars, and a pipeline (15) connected to the liquid space of the tank, and respective spreading devices connected to the pipeline at places of intended use for spreading out the fire extinguishing agent in the form of a foam once fire has been detected with a spray pressure exceeding a predetermined minimum value, characterized in that said no-combustible gas is partially dissolved or emulsified in the liquid as foam-forming gas and the same gas is used above the liquid level in said gas space as propellant gas, and the tank (10) is located at a place below the height of the majority of said places of intended use, said pipeline (15) extending substantially in vertical direction along the height of the building, branch sections (20) are connected to said pipeline (15) serving as connections to said spreading devices, and a valve system (12) for opening the path between the tank (10) and those of said spreading devices where and when fire has been detected, wherein the gas pressure in the tank (10) is composed of the sum of said minimum spray pressure required at or around the maximum height of said places and a driving pressure required to drive the foam composition after being released from the tank (10) to be raised to said highest place of intended use, and the tank (10) has a volume dimensioned to be sufficient for storing a volume of said pressurized liquid foam required for securely extinguishing fire in said building.

2. The fire fighting apparatus as claimed in claim 1, wherein said foam has a specific weight when having reached said spreading device around 0.1 g/cm³.

3. The fire fighting apparatus as claimed in claim 1, wherein said minimum spray pressure is around 5 bars.

4. The fire fighting apparatus as claimed in claim 1, wherein said building has a height exceeding 20 m.

5. The fire fighting apparatus as claimed in claim 1, wherein said spreading device comprises nozzles and/or sprinklers.

6. The fire fighting apparatus as claimed in claim 1, wherein said non-combustible gas is carbon dioxide.

7. The fire fighting apparatus as claimed in claim 1, wherein said tank (10) is arranged below the ground level, preferably in the basement of the building.
